(19) United States
(12) Patent Application Publication
(10) Pub. No.: US 2006/0185173 A1
(43) Pub. Date: Aug. 24, 2006

(54) Method and apparatus for removing dust from a workpiece

(76) Inventors: Brian Wadge, County Durham (GB); Stephen Houghton, New Castle upon Tyne (GB)

Correspondence Address: Bruce S Shapiro;Black & Decker Corporation, 701East Joppa Road TW 199, Towson, MD, 21286, US

(21) Appl. No.: 10/548,893

(22) PCT Filed: Mar. 11, 2004
(86) PCT No.: PCT/EP04/02517

§ 371 Date: Sep. 12, 2005

(30) Foreign Application Priority Data
Mar. 13, 2003 (GB) 0305714.8

(51) Int. Cl. B26B 3/00

(52) U.S. Cl. 30/165

(57) ABSTRACT

A jigsaw (2) having a housing (4) and a jigsaw support shoe (16) is disclosed. A motor in the housing (4) causes reciprocating motion of a jigsaw blade, and causes a fan in the housing to emit air from the housing. Air is driven by the fan via a connector piece (22) and a bridge member (20) towards the jigsaw blade in a direction transverse to a line of cutting action of the jigsaw (2). An inlet of a suction tube, connected to a source of suction such as a vacuum cleaner, is provided on the opposite side of the jigsaw blade to the bridge member (20). Provision of a stream of air in a direction transverse to the line of cutting action of the jigsaw (2) allows the outlet of the bridge member (20) to be located close to the jigsaw blade without obscuring the user's view of the location at which the blade cuts the workpiece, while the provision of an inlet to a suction tube on the opposite side of the jigsaw blade further constrains the stream of air to improve dust extraction.

The present invention relates to a method and apparatus for removing dust from a workpiece, and relates particularly, but not exclusively, to a method and apparatus for removing dust from a workpiece during a cutting operation thereon by a jigsaw.

Dust removal methods for jigsaws are well known, the two main methods consisting of blowing the dust out of the way of the jigsaw blade, or sucking the dust into a dust extraction device such as a vacuum cleaner. In either case, a blower or sucker is positioned immediately behind the jigsaw blade along the line of cutting action of the jigsaw blade. In particular, DE25462527, DE4316155, EPO347631 and EPO603552 all disclose arrangements in which a dust inlet connected to a suction source is arranged adjacent to the blade of a power saw. However, these known methods suffer from the drawback that if the blower or sucker is positioned too close to the blade it becomes obtrusive to a user of the jigsaw, whereas if it is too far away from the blade, it is insufficiently effective in extracting dust.

U.S. Pat. No. 5,680,704 discloses a jigsaw in which a cutting chip suction duct is arranged on a shoe of the jigsaw such that an inlet to the duct is arranged adjacent to and to one side of the jigsaw blade, the duct being connected to a source of suction such as a vacuum cleaner. By arranging the inlet to the duct to one side of the jigsaw blade, this provides the advantage that the duct can be located close to the blade without obscuring the jigsaw user's view of the blade at the location at which it cuts the workpiece.

Preferred embodiments of the present invention seek to improve the dust extraction performance of a cutting tool compared with prior art methods.

According to an aspect of the present invention, there is provided a method of removing dust from a workpiece during operation thereon by a power tool having a housing, a motor in the housing, and a working member adapted to be actuated by means of said motor, the method comprising directing a stream of pressurised gas onto said working member from a first side thereof and in a direction transverse to a line of action of the tool, and providing, on a second side of the working member opposite to said first side, an inlet to a suction tube connected to a suction source.

By providing an inlet to a suction tube connected to a suction source, the inlet being arranged on the opposite side of the working member of the tool to the side from which said stream of pressurized gas is provided, this provides the advantage of providing more constrained air flow than in the prior art, which in turn improves the dust extraction performance compared with prior art devices.

The pressurised gas may be air delivered by a fan used to cool said motor.

According to another aspect of the present invention, there is provided a dust extraction apparatus for use in removing dust from a workpiece during operation thereon by a power tool having a housing, a motor in the housing, a working member adapted to be actuated by means of said motor, and a support shoe adapted to engage the workpiece, the apparatus comprising:

gas inlet means adapted to be mounted to the housing for receiving pressurised gas from said housing;

gas outlet means adapted to be mounted to the shoe for directing at least part of said pressurised gas onto said working member from a first side thereof in a direction transverse to a line of action of the tool; and

dust inlet means adapted to be connected to a suction source and to be mounted to said shoe on a second side of said working member opposite to said first side.

The apparatus may further comprise at least one connecting portion for connecting said gas inlet means and said gas outlet means, wherein the or each said connecting portion is adapted to allow said gas outlet means to pivot with said shoe relative to said gas inlet means.

At least one said connecting portion may be flexible.

At least one said connecting portion may comprise a first part integral with one of said gas inlet means or said gas outlet means, and a second part integral with the other of said gas inlet means or said gas outlet means and at least partially received within said first part so as to be slidable relative to said first part.

This provides the advantage of enabling the connecting portion to be made from more durable material than in the case of a flexible connecting portion.

Said first and second parts may have mating curved surfaces in a plane substantially perpendicular to an axis of pivotal movement of the shoe relative to the housing.

The apparatus may further comprise resilient mounting means for mounting the gas outlet means to said shoe.

This provides the advantage of enabling the gas outlet means to be easily mounted to the shoe while enabling simple construction of the shoe, which in turn minimises the cost of production of a tool incorporating the apparatus.

Said dust inlet means may be removably mounted to said shoe in use and adapted to be mounted to either side of said working member.

According to a further aspect of the present invention, there is provided a power tool comprising a housing, a motor, an output shaft for supporting a working member and adapted to execute reciprocating movement in response to said motor, and a dust extraction apparatus as defined above.

The power tool may further comprise a fan for cooling said motor and adapted to supply flow of air to said gas inlet means.

A preferred embodiment of the invention will now be described, by way of example only and not in any limitative sense, with reference to the accompanying drawings, in which:

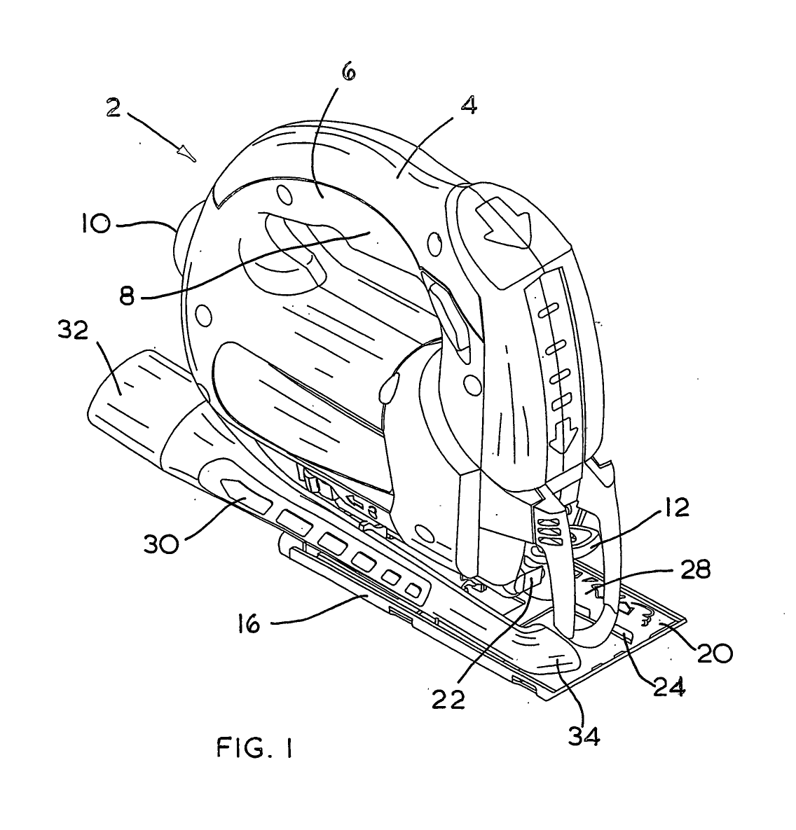

FIG. 1 is a front and right side perspective view of a jigsaw having a dust extraction apparatus embodying the present invention and with the jigsaw blade removed;

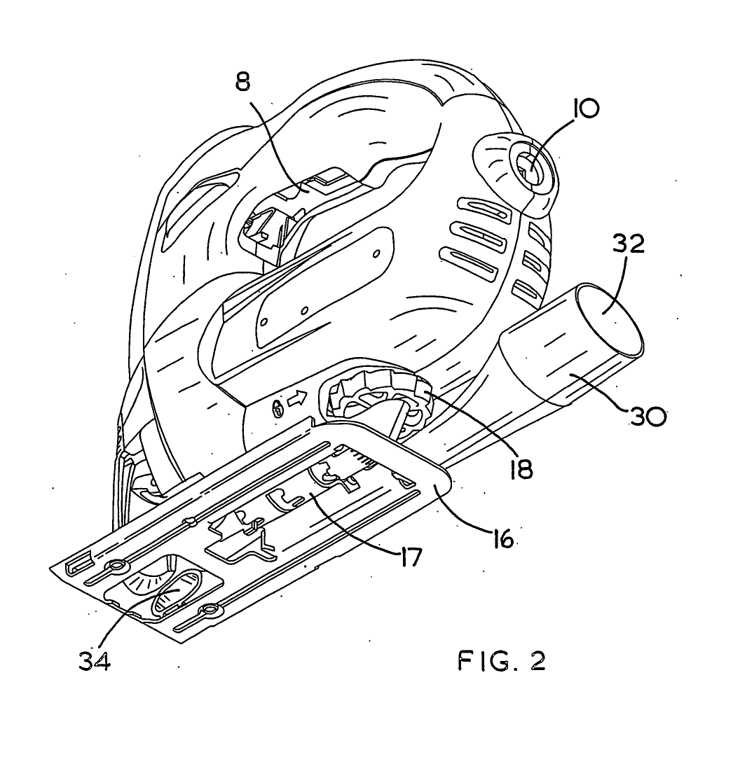

FIG. 2 is a bottom left side perspective view of the jigsaw of FIG. 1;

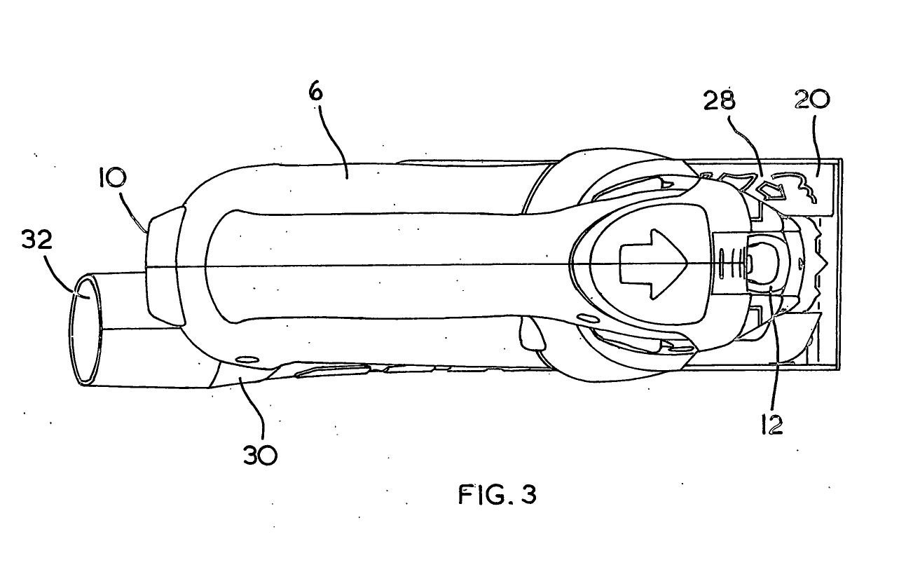

FIG. 3 is a top view of the jigsaw of FIG. 1;

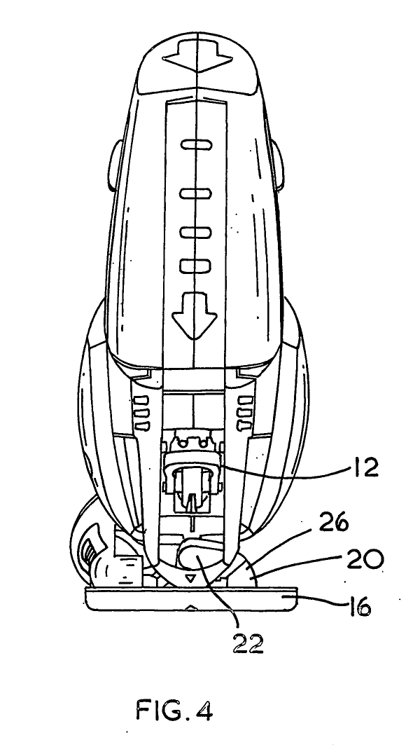

FIG. 4 is a front view of the jigsaw of FIG. 1;

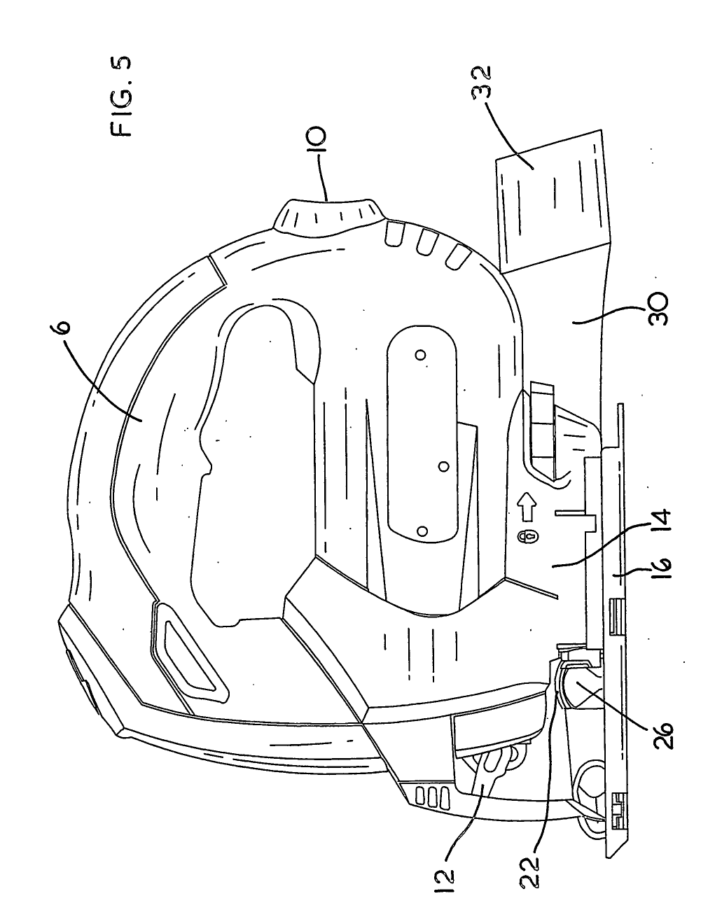

FIG. 5 is a left side elevation view of the jigsaw of FIG. 1;

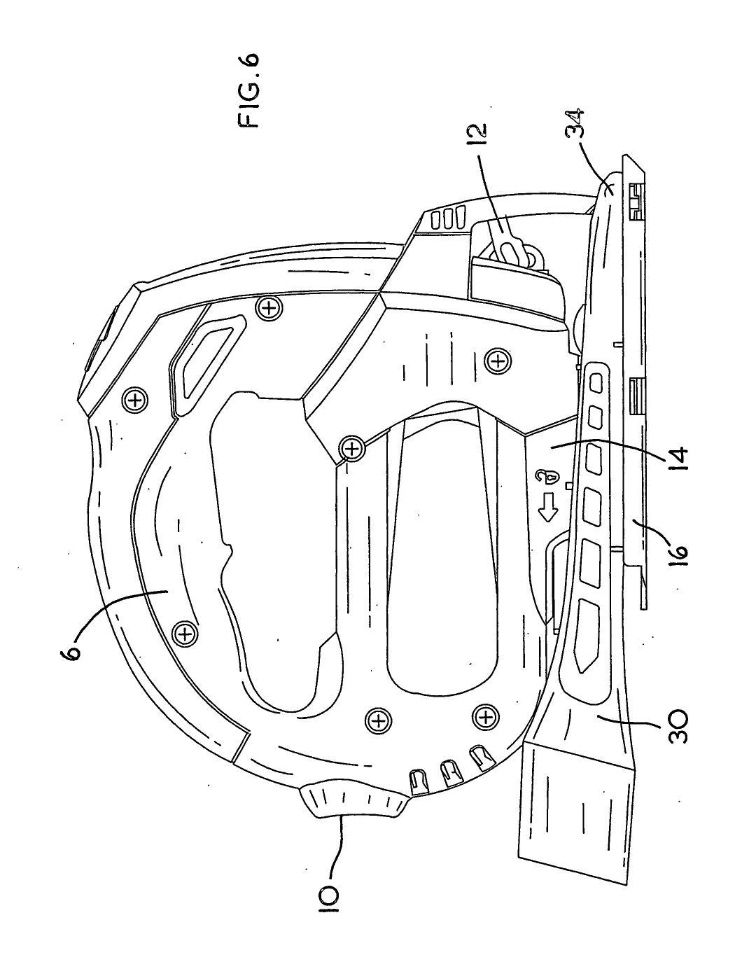

FIG. 6 is a right side elevation view of the jigsaw of FIG. 1;

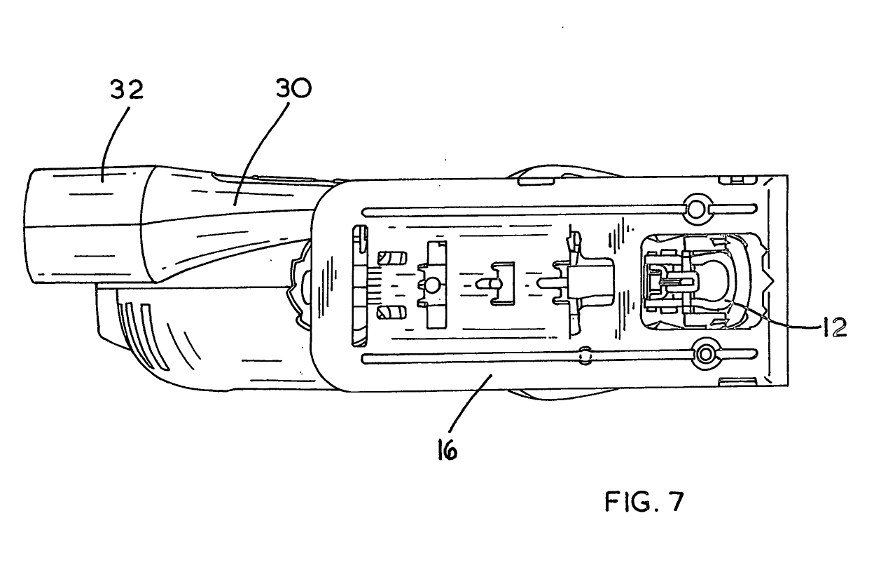

FIG. 7 is a bottom view of the jigsaw of FIG. 1; and

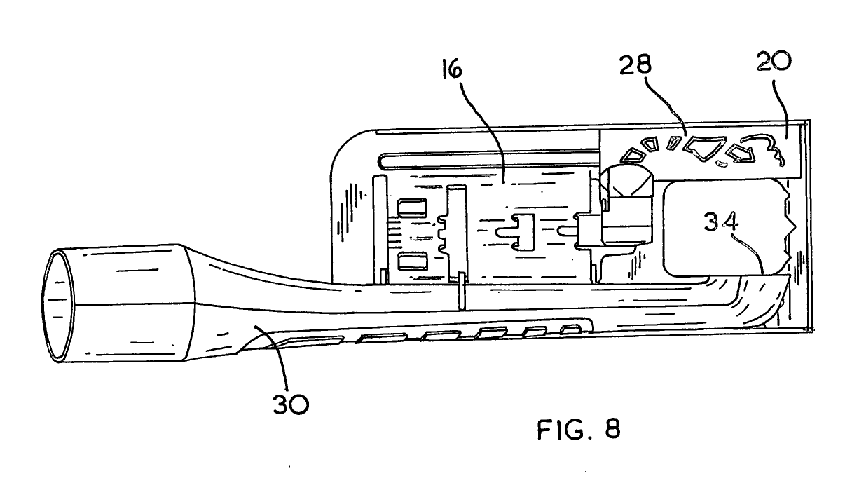

FIG. 8 is top view of the jigsaw support shoe and suction tube of the jigsaw of FIG. 1 with the rest of the jigsaw removed.

Referring to the Figures, a jigsaw 2 has a housing 4 in the form of a clam shell formed from two halves. The jigsaw 2 is formed so as to form a handle portion 6 to be gripped by a user, and defines a region 8 where a trigger (not shown) is formed so that the user can activate the jigsaw in order to cut a workpiece (not shown). Power is supplied to the jigsaw 2 via a power cord (not shown) passing through aperture 10 on actuation of the trigger.

A jigsaw blade clamp 12 is provided at the front portion of the jigsaw 4 to retain a jigsaw blade (not shown) on a drive shaft, such that actuation of the motor in housing 4 causes reciprocating motion of the jigsaw blade relative to the housing 4. When the user activates the trigger, electrical power is supplied via the power cord to the motor, which in turn rotates its output shaft. The output shaft has a splined drive at the distal end thereof, the drive communicating with a gear wheel. The gear wheel has an eccentric mounted thereon which couples with a reciprocating drive shaft which has at its lower end the blade clamp 12. In this way, rotation of the output shaft causes reciprocating motion of the drive shaft and the jigsaw blade attached to the drive shaft.

The lower portions of the two clam shell halves define a lower portion 14 which provides a duct through which air may be blown. The duct is formed by channeling in the clam shell half so that a continuous channel is formed to enable the duct to communicate with the jigsaw fan (not shown) in the housing 4 which also serves, as will be appreciated by persons skilled in the art, to cool the jigsaw motor during use of the jigsaw. Actuation of the motor causes rotation of the fan blades which causes a stream of air to be forced from the duct in order to cool the motor. This stream of air is also utilised to blow dust, produced during the cutting operation of the jigsaw, from a workpiece being cut, as will be described in greater detail below.

A jigsaw support shoe 16, which is preferably stamped from a single piece of metal, is provided with a concave support surface 17. The concave support surface is arranged to mate with the lower portion of the jigsaw body 4 such that coupling of the convex profile of the lower portion with the concave profile of the support surface enables the support shoe 16 to be pivoted relative to the jigsaw body 4 to allow for bevel cutting. The support shoe 16 can be locked in position in a number of orientations relative to the housing 4 by means of a clamping wheel 18 connected to the support shoe 16 via a gear mechanism (not shown).

The jigsaw support shoe 16 receives a bridge member 20 which clips into a corner of the support shoe 16 to define a conduit for transporting air from the duct to the position at which the jigsaw blade, not shown, cuts through the workpiece. This is achieved by the bridge member 20 coupling with a connector piece 22 situated between the output of the duct and the input portion of the bridge member 20, the bridge member 20 and connector piece 22 being separate elements. The bridge member 20 is hollow so as to provide a channel through which air may be vented between the jigsaw body lower portion and an outlet 24 of the bridge member 20 directing air to that piece of the workpiece being cut by the jigsaw blade.

The connector piece 22 couples with an input portion 26 of the bridge member 20. The connector piece 22 has an input port of generally circular cross-section which protrudes into the external portion of the duct of the lower portion of the jigsaw body 4. The input port of the connector piece 22 is of generally circular cross-section so as to allow pivoting of the support shoe 16 relative to the jigsaw body 4, and the connector piece 22 also serves to rotate the flow of air exiting the duct through approximately 90° so that it can pass to the input portion of the bridge member 20 to be directed via the outlet 24 of the bridge member towards the jigsaw blade. Air which has entered into the input port of the connector piece 22 and then been rotated through 90° enters the bridge member 20 via its input portion. Because of the hollow internal structure of the bridge member 20, air passes through the main extending arm 28 of the bridge member 20 from where it is ejected via outlet 24 so as to strike the jigsaw blade from one side thereof.

A suction tube 30 has an outlet 32 connected to a source of suction such as a vacuum cleaner (not shown) and is removably mounted to the side of the support shoe 16 on the side thereof opposite to the side on which the bridge member 20 is located, such that an inlet 34 of the suction tube 30 is located to one side of and adjacent to the jigsaw blade.

The operation of the jigsaw 2 shown in the Figures will now be described.

In order to remove dust from that part of a workpiece being cut by the saw 2 during the cutting operation, air is directed from the outlet 24 of bridge member 20 onto a side of the saw blade by virtue of actuation of the saw motor operating the fan as well as the saw blade drive mechanism. The air is directed in a direction transverse to the line of action of the saw, as a result of which the outlet 24 of bridge member 20 can be located close to the blade so that it is effective without being obtrusive to a user of the jigsaw. At the same time, the suction source to which the outlet 32 of suction tube 30 is connected is actuated. This further constrains the flow of air flowing from the outlet 24 of the bridge member 20 to the inlet 34 of the suction tube 30, as a result of which the dust extraction operation of the jigsaw is improved compared with the prior art.

It will be appreciated by persons skilled in the art that the above embodiment has been described by way of example only, and not in any limitative sense, and that various alterations and modifications are possible without departure from the scope of the invention as defined by the appended claims. For example, the bridge member 20 and connector piece 22 may be formed as a single unit, and the bridge member 20 and suction tube 30 may be provided on the opposite sides of the jigsaw blade to those shown in the Figures.

1. A method of removing dust from a workpiece during operation thereon by a power tool having a housing, a motor in the housing, and a working member adapted to be actuated by means of said motor, the method comprising directing a stream of pressurised gas onto said working member from a first side thereof and in a direction transverse to a line of action of the tool, and providing, on a second side of the working member opposite to said first side, an inlet to a suction tube connected to a suction source.

2. A method according to claim 1, wherein the pressurised gas is air delivered by a fan used to cool said motor.

3. A method of removing dust from a workpiece during operation thereon by a power tool having a housing, a motor in the housing, and a working member adapted to be actuated by means of said motor, the method substantially as hereinbefore described with reference to the accompanying drawings.

4. A dust extraction apparatus for use in removing dust from a workpiece during operation thereon by a power tool having a housing, a motor in the housing, a working member adapted to be actuated by means of said motor, and a support shoe adapted to engage the workpiece, the apparatus comprising:
gas inlet means adapted to be mounted to the housing for receiving pressurised gas from said housing;
gas outlet means adapted to be mounted to the shoe for directing at least part of said pressurised gas onto said working member from a first side thereof in a direction transverse to a line of action of the tool; and
dust inlet means adapted to be connected to a suction source and to be mounted to said shoe on a second side of said working member opposite to said first side.

5. An apparatus according to claim 4, further comprising at least one connecting portion for connecting said gas inlet means and said gas outlet means, wherein the or each said connecting portion is adapted to allow said gas outlet means to pivot with said shoe relative to said gas inlet means.

6. An apparatus according to claim 5, wherein at least one said connecting portion is flexible.

7. An apparatus according to claim 5 or 6, wherein at least one said connecting portion comprises a first part integral with one of said gas inlet means or said gas outlet means, and a second part integral with the other of said gas inlet means or said gas outlet means and at least partially received within said first part so as to be slidable relative to said first part.

8. An apparatus according to claim 7, wherein said first and second parts have mating curved surfaces in a plane substantially perpendicular to an axis of pivotal movement of the shoe relative to the housing.

9. An apparatus according to any one of claims 4 to 8, further comprising resilient mounting means for mounting the gas outlet means to said shoe.

10. An apparatus according to any one of claims 4 to 9, wherein said dust inlet means is removably mounted to said shoe in use and adapted to be mounted to either side of said working member.

11. A dust extraction apparatus for use in removing dust from a workpiece during operation thereon by a power tool having a housing, a motor in the housing, a working member adapted to be actuated by means of said motor, and a support shoe adapted to engage the workpiece, the apparatus substantially as hereinbefore described with reference to the accompanying drawings.

12. A power tool comprising a housing, a motor in the housing, an output shaft for supporting a working member and adapted to execute reciprocating movement in response to said motor, a support shoe adapted to engage the workpiece, and a dust extraction apparatus according to any one of claims 4 to 11.

13. A tool according to claim 12, further comprising a fan for cooling said motor and adapted to supply flow of air to said gas inlet means.
